(19) United States
(12) Patent Application Publication
(10) Pub. No.: US 2024/0403563 A1
(43) Pub. Date: Dec. 5, 2024

(54) INTER-INSTITUTIONAL TEXT ANALYSIS AND COMPARISON TOOL

(71) Applicant: Synchro AI, LLC, Boerne, TX (US)

(72) Inventors: Marshall L. Bex, IV, Boerne, TX (US); Laci G. Bex, Boerne, TX (US); Jyunmi Hatcher, Boerne, TX (US)

(73) Assignee: Synchro AI, LLC, Boerne, TX (US)

(21) Appl. No.: 18/675,924

(22) Filed: May 28, 2024

Related U.S. Application Data
(60) Provisional application No. 63/470,397, filed on Jun. 1, 2023.

(51) Int. Cl. G06F 40/30; G06F 16/383; G06V 30/412

(52) U.S. Cl. CPC G06F 40/30; G06F 16/383; G06V 30/412

(57) ABSTRACT

A platform includes a user interface able to receive a text document and/or a user prompt. The platform is able to receive a second text document to perform a one-to-one comparison or access a database including a plurality of documents to evaluate similarity of the input text document to a larger corpus of documents. The platform includes a natural language processing module for parsing the text document and a machine learning module for evaluating semantic similarity between the input text document and one or more other documents. The platform is then able to generate a similarity score for the text document. The machine learning module is further capable of automatically detecting different sections of the input text document and generating similarity scores for each individual section compared to analogous sections in one or more other documents.

### CROSS-REFERENCE TO RELATED APPLICATIONS

This application is related to and claims priority from the following US patents and patent applications: this application claims priority from and the benefit of U.S. Provisional Patent Application No. 63/470,397, filed Jun. 1, 2023, which is incorporated herein by reference in its entirety.

### BACKGROUND OF THE INVENTION

### 1. Field of the Invention

The present invention relates to semantic text analysis systems, and more specifically to semantic comparison tools for evaluating similarity and equivalency between documents and text produced by different institutions or different fields of knowledge.

### 2. Description of the Prior Art

It is generally known in the prior art to provide natural language processing tools capable of performing semantic analysis on text sources. Furthermore, tools text using such semantic analysis for search purposes. Techniques such as latent semantic analysis are capable of building a corpus of documents with semantic relationships between each document.

Prior art patent documents include the following:

U.S. Pat. No. 9,824,153 for Systems and methods for determining the sufficiency of a curriculum in meeting standards by inventors Liang et al., filed Nov. 21, 2014 and issued Nov. 21, 2017, discloses a system and method for analyzing curricular materials to determine the sufficiency of a curriculum in meeting a set of standards. Curricular materials are imported into a database which can include converting the curricular materials into electronic form and converting any non-text material to text, tagging all text with identifying information and saving it to a database. Standards are imported and used to develop a plurality of search queries. Creating the search queries can comprise dividing the standards into criteria, creating a rubric based on the criteria, creating a syllabus comprised of syllabus elements based on the rubric, and then creating the search query based on the syllabus. The search queries are performed on the database. A grade on the effectiveness of the curricular materials in meeting the standards can be assigned. The results can be delivered to a user via a user interface.

U.S. Pat. No. 9,177,078 for Systems and methods for analysis of international education credential equivalence by inventors Assefa et al., filed Feb. 19, 2010 and issued Nov. 3, 2015, discloses a system for converting educational credentials from a first country to credentials for a second country including a database configured to store data related to at least one of grading scales, credit scales, course descriptions, rankings, and weighting for educational credentials and a processor configured to receive data from a user related to course grades and credits earned in the first country and a selection of the second country. The processor retrieves data from the database based on the user data and converting the course grades and credits earned in the first country to grades, credits, and grade point averages for use in the second country based on the data from the database. The processor provides the grades, credits, and grade point averages equivalent in the second country to an electronic display for display to the user.

US Patent Pub. No. 2023/0019862 for Systems and methods providing medical privileging and data over data networks using a distributed ledger by inventor Vines, filed Mar. 3, 2022 and published Jan. 19, 2023, discloses systems and methods providing credentialing and privilege processing, management, control and exchanges of data for authorized users. A server accessible from clients over a data network can provide centralized credentialing forms, receive supplemental information in association with medical provider application, and authenticate and grant access to records and forms associated with the medical provider to hospitals and third party institutions authorized by the medical provider to access and provide records in support of the medical provider's application for privileges, and thereby access, to medical providing institutions. Artificial intelligence and distributed ledger interaction with the server enhances application processing and controlled access to data.

U.S. Pat. No. 9,672,206 for Apparatus, system and method for application-specific and customizable semantic similarity measurement by inventors Carus et al., filed Jun. 1, 2015 and issued Jun. 6, 2017, discloses an apparatus system and method for creating a customizable and application-specific semantic similarity utility that uses a single similarity measuring algorithm with data from broad-coverage structured lexical knowledge bases (dictionaries and thesauri) and corpora (document collections). More specifically the invention includes the use of data from custom or application-specific structured lexical knowledge bases and corpora and semantic mappings from variant expressions to their canonical forms. The invention uses a combination of technologies to simplify the development of a generic semantic similarity utility; and minimize the effort and complexity of customizing the generic utility for a domain- or topic-dependent application. The invention makes customization modular and data-driven, allowing developers to create implementations at varying degrees of customization (e.g., generic, domain-level, company-level, application-level) and also as changes occur over time (e.g., when product and service mixes change).

U.S. Pat. No. 11,314,807 for Methods and Systems for Comparison of Structured Documents by inventors Hershowitz et al., filed May 18, 2018 and issued Apr. 26, 2022, discloses systems and methods of comparing structured documents. From/to source documents are first represented by their respective from/to XML forms based on a predetermined schema. One or more from nodes are selected from the from XML document to compare to one or more to nodes from the to XML document. The comparison employs a set of matching functions that may be selected based on the domain of the source documents. The matching functions may compare just the tags of XML elements, and/or their text contents and/or any of their relevant attributes. The matching may be exact or approximate. Each matching function computes a score which may be weighted. For each pair of from/to nodes, an overall match-score is computed based on the scores of the individual matching functions. If the match-score reaches a matching-threshold, the pair is determined to be a match and further matching is stopped. The techniques are extended for comparing multiple from documents to a to document.

US Patent Pub. No. 2010/0217766 for Mapping Courses to Program Competencies by inventors Perlin et al., filed Feb. 24, 2010 and published Aug. 26, 2010, discloses a mapping device configured to map accreditation data to curriculum data. A mapping device may include an accreditation module, a curriculum module and/or a mapping module. An accreditation module may be configured to retrieve accreditation data. A curriculum module may be configured to retrieve curriculum data. A mapping module may be configured to map one or more competencies and/or one or more accreditation content areas to one or more course contents and/or one or more course objectives. A mapping device may include an analytical module, which may be configured to identify deficiencies, and/or an alignment module, which may be configured to address one or more deficiencies. A mapping device may be configured to employ a linkage template, which may include an academic level, and/or may employ a leveling rubric, which may be multi-leveled. A mapping module may be configured to generate an output graph, which may implement weights.

US Patent Pub. No. 2018/0330385 for Automated and distributed verification for certification and license data by inventors Johnson et al., filed May 10, 2018 and published Nov. 15, 2018, discloses a technological solution to the problem of automating the verification of Cert Org credential records, as well as monitoring licenses/certifications with a compliance screenshot, and providing automated alerts/notifications and data analytics. The verification and monitoring process can be used for employees, freelancers or consultants, represented licensees (e.g., contractors, nurses, insurance brokers, accountants, pharmacists, etc.) and partners or customers (e.g. drug distribution, insurance, contractors, etc.) across Cert Orgs. Cert Orgs include technology providers, State License Boards, Federal Databases and many others. The system provides corporations with continuous verification of credential data across structured and unstructured data outputs of certifying organizations. Fully automated and scheduled monitoring allows the system to verify credential status, with corresponding compliance screenshots, on an ongoing basis with custom triggers for alerts in change in status, whether normal expiration, disciplinary or administrative action, revocations and pre-expiration for proactive decisions (e.g., remove freelancer or drug distribution customer from portfolio).

US Patent Pub. No. 2017/0178264 for Transfer Credit Evaluation System and Method by inventors Cosker et al., filed Mar. 24, 2015 and published Jun. 22, 2017, discloses a system and method for granting course credits by a first educational institution from a second educational institution. A processor at a first educational institution receives a transcript from a student and converts the transcript to a format that allows transcript data to be obtained and reviewed in an automated fashions based on criteria. Course identifying information is determined and compared by the processor to course identifying information stored in a datastore. The processor then determines what courses are eligible for transfer credit when the course identifying information in the transcript data matches at least in part course identifying information stored in the datastore. The processor may also post granted credits to a student's academic plan.

### SUMMARY OF THE INVENTION

The present invention relates to semantic text analysis systems, and more specifically to semantic comparison tools for evaluating similarity and equivalency between documents and text produced by different institutions.

It is an object of this invention to provide a system and method for comparing credential documents between multiple institutions to evaluate equivalency of the credentials, licenses, certifications, and other documentation, or to compare descriptions of services provided by multiple institutions to determine similarity of provided services. Therefore, it is an object to provide a system that facilitates easier standards-conscious inter-institutional exchange of people or information.

In one embodiment, the present invention is directed to a system for evaluating and comparing credentials from separate institutions, including a server platform, wherein the server platform includes a processor and a memory, a data collection module of the server platform configured to receive one or more text documents from a user device, a machine learning module of the server platform configured to break up each of the one or more text documents into a plurality of sections based on structural and/or semantic qualities of the one or more text documents, a natural language processing (NLP) module of the server platform configured to perform semantic analysis on the one or more text documents, wherein the data collection module is configured to retrieve one or more additional text documents from one or more field knowledge databases, wherein an assessment scale generator of the server platform generates similarity scores between the plurality of sections of the one or more text documents and a plurality of sections of the one or more additional text documents, and wherein the one or more text documents include one or more academic transcripts.

In another embodiment, the present invention is directed to a method for evaluating and comparing credentials from separate institutions, including providing a server platform including a processor and a memory, a data collection module of the server platform receiving one or more text documents from a user device, a machine learning module of the server platform breaking up each of the one or more text documents into a plurality of sections based on structural and/or semantic qualities of the one or more text documents, a natural language processing (NLP) module of the server platform performing semantic analysis on the one or more text documents, the data collection module retrieving one or more additional text documents from one or more field knowledge databases, an assessment scale generator of the server platform generating similarity scores between the plurality of sections of the one or more text documents and a plurality of sections of the one or more additional text documents, and wherein the one or more text documents include one or more academic transcripts.

In yet another embodiment, the present invention is directed to a system for evaluating and comparing credentials from separate institutions, including a server platform, wherein the server platform includes a processor and a memory, a data collection module of the server platform configured to receive one or more text documents from a user device, a machine learning module of the server platform configured to break up each of the one or more text documents into a plurality of sections based on structural and/or semantic qualities of the one or more text documents, a natural language processing (NLP) module of the server platform configured to perform semantic analysis on the one or more text documents, wherein the data collection module is configured to retrieve one or more additional text documents from one or more field knowledge databases, wherein an assessment scale generator of the server platform generates similarity scores between the plurality of sections of the one or more text documents and a plurality of sections of the one or more additional text documents, and wherein the assessment scale generator receives user-defined criteria defining one or more types of sections of the one or more text documents are high relevance, low relevance, or no relevance, and wherein the assessment scale generator generates the similarity scores in part based on the received user-defined criteria.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a schematic diagram for a system of semantically comparing two credentials and producing an assessment according to one embodiment of the present invention.

FIG. 2 illustrates an assessment page of a graphical user interface (GUI) for a system of comparing text data according to one embodiment of the present invention.

FIG. 3 illustrates a flow diagram for a system of comparing text data and sections of text data using machine learning according to one embodiment of the present invention.

FIG. 4 illustrates a schematic diagram for a system receiving a user prompt and semantically evaluating the document in comparison to a database of related documents according to one embodiment of the present invention.

FIG. 5 is a schematic diagram of a system of the present invention.

### DETAILED DESCRIPTION

The present invention is generally directed to semantic text analysis systems, and more specifically to semantic comparison tools for evaluating similarity and equivalency between documents and text produced by different institutions.

In one embodiment, the present invention is directed to a system for evaluating and comparing credentials from separate institutions, including a server platform, wherein the server platform includes a processor and a memory, a data collection module of the server platform configured to receive one or more text documents from a user device, a machine learning module of the server platform configured to break up each of the one or more text documents into a plurality of sections based on structural and/or semantic qualities of the one or more text documents, a natural language processing (NLP) module of the server platform configured to perform semantic analysis on the one or more text documents, wherein the data collection module is configured to retrieve one or more additional text documents from one or more field knowledge databases, wherein an assessment scale generator of the server platform generates similarity scores between the plurality of sections of the one or more text documents and a plurality of sections of the one or more additional text documents, and wherein the one or more text documents include one or more academic transcripts.

In another embodiment, the present invention is directed to a method for evaluating and comparing credentials from separate institutions, including providing a server platform including a processor and a memory, a data collection module of the server platform receiving one or more text documents from a user device, a machine learning module of the server platform breaking up each of the one or more text documents into a plurality of sections based on structural and/or semantic qualities of the one or more text documents, a natural language processing (NLP) module of the server platform performing semantic analysis on the one or more text documents, the data collection module retrieving one or more additional text documents from one or more field knowledge databases, an assessment scale generator of the server platform generating similarity scores between the plurality of sections of the one or more text documents and a plurality of sections of the one or more additional text documents, and wherein the one or more text documents include one or more academic transcripts.

In yet another embodiment, the present invention is directed to a system for evaluating and comparing credentials from separate institutions, including a server platform, wherein the server platform includes a processor and a memory, a data collection module of the server platform configured to receive one or more text documents from a user device, a machine learning module of the server platform configured to break up each of the one or more text documents into a plurality of sections based on structural and/or semantic qualities of the one or more text documents, a natural language processing (NLP) module of the server platform configured to perform semantic analysis on the one or more text documents, wherein the data collection module is configured to retrieve one or more additional text documents from one or more field knowledge databases, wherein an assessment scale generator of the server platform generates similarity scores between the plurality of sections of the one or more text documents and a plurality of sections of the one or more additional text documents, and wherein the assessment scale generator receives user-defined criteria defining one or more types of sections of the one or more text documents are high relevance, low relevance, or no relevance, and wherein the assessment scale generator generates the similarity scores in part based on the received user-defined criteria.

Inter-institutional credential comparison is an issue for any agency, company, or industry where it is important to evaluate whether the qualifications, credentials, or experience of an individual align with standards of the institution. Because different institutions often use different wording to describe essentially the same qualifications, it is important for institutions to carefully evaluate not only a basic description of an individual's background, but also the context of what that description means for the institution where the individual previously was. Otherwise, individuals are easily improperly rejected, causing the institution to either reject specific individuals that are otherwise qualified, or causing the institution to develop systemic bias against specific other institutions entirely based on word choice by the other institution. On the other hand, other institutions will sometimes use the same basic description to describe two entirely different qualifications, potentially leading unqualified individuals to be accepted at the institution or to be given certain credentials without proper qualifications. In the prior art, the remedy for this often requires long, particularized analysis of other institutional standards, or require the institution to reevaluate the qualifications of the individual with their own tests or paperwork. Both of these options, however, are very inefficient, costing additional time, cost, and personnel that the institution often cannot practically afford.

One example of this issue is in academia, where transferring credits between institutions is important when students transfer between schools, or when graduate schools are attempting to evaluate the transcripts of applicants. Course number codes are notoriously unreliable, as, for example, Biology 101, an introductory biology course, at a first school is frequently equivalent to Biology 201 at another school or Biology 3 at a third school. Furthermore, even if the institutions know the correlation between different course numbers (e.g., Biology 101 at school 1=Biology 201 at school 2), two introductory biology classes, for example, are not necessarily equivalent. Some introductory biology classes include a dedicated unit on genetics, while others leave that for a second course. Without knowledge that two similar classes actually include the same important information or units, universities often resort to uniformly rejecting credits from outside institutions or only accept credits from very specific, known institutions, leading students to have to essentially repeat courses.

From a regulatory perspective, a first government entity (e.g., a first state) will often issue a credential (e.g., a hunting license) equivalent to ones granted in a second government entity (e.g., a second state). In some situations, these credentials have different requirements in different jurisdictions (e.g., one jurisdiction requires a background check and another doesn't) and the second government entity does not want to grant the credential without the individual reapplying in order to meet the standards. However, in other situations, the credentials are functionally equivalent or the second government entity has a set of requirements that are a mere subset of the requirements from the first government entity, allowing the second government entity to comfortably grant the license without further paperwork. While institutions occasionally have good reason to artificial increase the barrier to receiving the credential (e.g., to maintain a limited total number of granted hunting licenses in a particular area), in other situations, requirements to reassess credentials due to lack of knowledge of the requirements of another area or institution create onerous barriers to movement of individuals that potentially cause negative impacts to all involved parties.

Therefore, a system is needed for automatically determining similarity between different course descriptions, credential requirements, or other form of qualifications from multiple institutions in order to generate similarity metrics for determining if standards at a second institution are sufficient to accept at a primary institution. Furthermore, it is needed for such a system to utilize semantic analysis, to avoid false negatives arising from different wording being used by different institutions.

Referring now to the drawings in general, the illustrations are for the purpose of describing one or more preferred embodiments of the invention and are not intended to limit the invention thereto.

The platform is operable to utilize a plurality of learning techniques including, but not limited to, machine learning (ML), artificial intelligence (AI), deep learning (DL), neural networks (NNs), artificial neural networks (ANNs), support vector machines (SVMs), Markov decision process (MDP), and/or natural language processing (NLP). The platform is operable to use any of the aforementioned learning techniques alone or in combination.

Further, the platform is operable to utilize predictive analytics techniques including, but not limited to, machine learning (ML), artificial intelligence (AI), neural networks (NNs) (e.g., long short term memory (LSTM) neural networks), deep learning, historical data, and/or data mining to make future predictions and/or models. The platform is preferably operable to recommend and/or perform actions based on historical data, external data sources, ML, AI, NNs, and/or other learning techniques. The platform is operable to utilize predictive modeling and/or optimization algorithms including, but not limited to, heuristic algorithms, particle swarm optimization, genetic algorithms, technical analysis descriptors, combinatorial algorithms, quantum optimization algorithms, iterative methods, deep learning techniques, and/or feature selection techniques.

The present system includes a platform including a server and a database. The server is in communication from a plurality of user devices (e.g., smartphones, tablets, computers, etc.) and is capable of generating a plurality of user profiles based on input from the plurality of user devices. The platform is capable of being accessed by a native application or a web-based application on the plurality of user devices and the platform includes a graphical user interface (GUI) for receiving inputs from the plurality of user devices and displaying data from the platform. One of ordinary skill in the art will understand that the operating systems on which the platform is capable of operating are not intended to be limiting and include at least the following operating systems: WINDOWS (WINDOWS 11, WINDOWS 10, WINDOWS 8, WINDOWS VISTA, WINDOWS XP, etc.), macOS, IOS, ANDROID, LINUX, UBUNTU, UNIX, CHROMEOS, and any other operating systems.

The platform is able to be used for analysis of qualifications and credentials for a plurality of different fields. In one embodiment, the platform is used for comparisons of course equivalencies, taking into account, for example, syllabi, course descriptions, previous exams, previous homework (or other assignments), slide decks, used textbooks, learning outcomes, course audio, course video, one or more public course notes, and/or other materials. Course descriptions are able to be evaluating for many different levels of schooling, including preschool, elementary school, middle school, high school, university, and graduate school. In one embodiment, the platform is used to analyze healthcare credentials, such as evaluating criteria and requirements for becoming a registered nurse or obtaining a license to practice as a physician. By way of example and not limitation, the system is able to analyze similarity between requirements to become a physician in a first country (or state) compared to a second country (or state) and automatically detect a percentage similarity in these requirements. Alternatively, the system is able to determine similarity between requirements in multiple medical disciplines. Examination of licenses and certifications is not, however, limited to the medical professional. In one embodiment, the platform is used to analyze similarity of requirements for ambulance workers, firefighters, policemen, electricians, plumbers, realtors, certified financial advisors, accountants, attorneys, pilots, ship captains, commercial truck drivers, or for getting security clearance in one or more different agencies. The platform is not limited to evaluating credentials or licenses held personally by individuals, but is also able to determine equivalency in requirements for inspections of property (e.g., car inspections, health and safety regulations for buildings) or for suitability of documents analyzed by different agencies (e.g., patents and trademarks filed in different countries). In each case, the platform is able to determine equivalency of documents produced, generated, or analyzed by different individuals or different groups, or produced under different systems or laws.

Furthermore, one of ordinary skill in the art will understand that where this application provides mention of certifications, the system is equally capable of performing similarity on other types of documents, such as patents, license agreements, transcripts, syllabi (or other course materials), letters of recommendation, resumes, medical records, licenses (e.g., medical licenses, gun licenses, etc.), and/or any other type of text document.

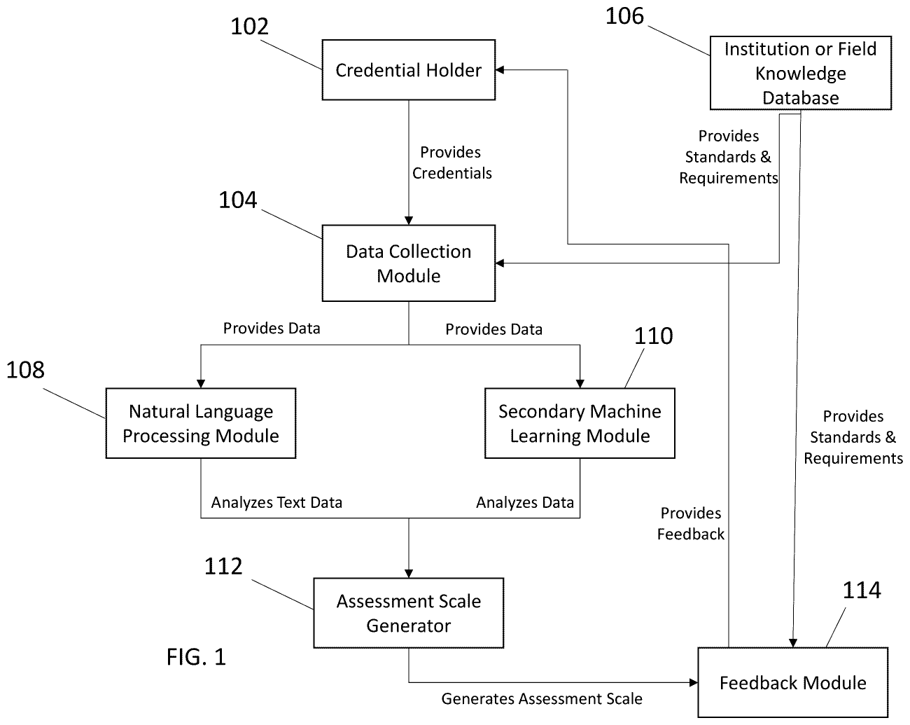

FIG. 1 illustrates a schematic diagram for a system of semantically comparing two credentials and producing an assessment according to one embodiment of the present invention. A credential holder 102 (e.g., a user profile uploading credential information into the platform) provides information corresponding to a credential. In one embodiment, credentials are provided as text documents (e.g., .doc files, .docx files, pdf files, .txt files, .rtf files, .tex files, .odt files, .wpd files, etc.) uploaded by the credential holder profile and stored on at least one database associated with the platform. In another embodiment, rather than uploaded a document, the platform receives a text input (e.g., copied and pasted text). In yet another embodiment, the platform receives at least one hyperlink to at least one external website or database including recordation of the credential and the platform includes a web crawler module configured to automatically scrape information from the linked external website or database to retrieve the credential. In still another embodiment, the platform does not receive a hyperlink, but receives a plain language description of where the credentials are located, which is first analyzed using at least one natural language processing module and subsequently the web crawler module is used to retrieve the credential from the described location.

The credentials, in whichever form they are provided, are collected by a data collection module 104. In one embodiment, the data collection module also collects data related to the credentials from one or more institutions or field knowledge databases 106. In one embodiment, the data related to the credentials includes descriptions of the credentials applied by the granting institution, requirements for obtaining the credential, one or more example documents corresponding to the credential from one or more different institutions, and/or other information related to the credential. In one embodiment, where the credential is related to an educational course, the descriptions of the credentials include syllabi, course descriptions, past exams, past homework, slide decks, and/or other text documents related to the course through the institution. In another embodiment, where the credential is a license, the descriptions of the credentials include descriptions of what privileges the credential grants, where and when the privileges are granted, and/or any other limitations on the granted privileges. In one embodiment, the data collection module 104 includes document parsing functionality (e.g., optical character recognition) and automatically generates at least one text transcript of uploaded documents that are capable of being fed into one or more machine learning modules for further analysis.

In one embodiment, a natural language processing module 108 receives text data from the data collection module 104 and automatically performs semantic analysis on the received text data. In one embodiment, the natural language processing module 108 utilizes any latent semantic analysis technique known in the art, including but not limited to those described in U.S. Pat. Nos. 9,020,810, 7,440,947, 7,856,438, and/or any other prior art techniques. In one embodiment, the natural language processing module 108 is capable of performing any sub-technique associated with semantic analysis, including topic classification, sentiment analysis, intent classification, keyword extraction, entity extraction, and/or any other form of semantic analysis. In one embodiment, the semantic analysis modules are trained using a large corpus of similar documents to determine common terms and phrases used in all documents of the same genre (e.g., similarities between all syllabi) and terms and phrases indicating specific topics or information (e.g., terms and phrases unique to syllabi concerning genetics courses). In one embodiment, the natural language processing module 108 generates one or more topics, subjects, and/or categories covered by the analyzed text data. In one embodiment, the natural language processing module 108 receives metadata associated with the received text data and/or the large corpus of similar documents. In one embodiment, the metadata includes a data of creation for one or more text files and/or a location of creation of one or more text files. In one embodiment, metadata is used to refine likely topic detection and/or other semantic analysis techniques (e.g., the model is able to detect when certain topics first appear, such as cryptocurrency, and automatically determine that documents produced before this initial date are unlikely to concern cryptocurrency). In one embodiment, the natural language processing module utilizes, in addition to semantic analysis, lexical analysis, syntactic analysis, discourse analysis, and/or any other language analysis technique.

In one embodiment, a secondary machine learning module 110 also receives text data from the data collection module 104. In one embodiment, the secondary machine learning module 110 is able to perform analysis tasks on the text data other than the semantic analysis performed by the natural language processing module 108. For example, in one embodiment, the secondary machine learning module 110 is able to identify one or more sections and/or topic areas of the text data. In one embodiment, sections are identified based on text size, line spacing, page breaks, and/or areas of the text determined to concern new topics by the natural language processing module 108. In one embodiment, the secondary machine learning module 110 automatically determines one or more sections of the text data to automatically exclude from the similarity analysis. This is useful if there are long sections of the text that are irrelevant to the task at hand (e.g., for syllabi, sections that concern grading criteria and phone policies, rather than substantive materials). In one embodiment information regarding which sections are relevant for comparison purposes are fed from the secondary machine learning module 110 to the natural language processing module 108 before the natural language processing module 108 begins analysis, to limit the amount of time or resources spent on irrelevant material. In one embodiment, which sections are excluded are based, at least in part, on a user prompt received by the credential holder 102. In this way, the credential holder 102 is able to specify whether information such as grading criteria or course curve data is relevant or irrelevant in the similarity analysis.

In one embodiment, the secondary machine learning module 110 utilizes, supervised learning algorithms, unsupervised learning algorithms, semi-supervised learning algorithms, reinforcement learning algorithms, and/or any other type of learning algorithm known in the art.

While FIG. 1 depicts the natural language processing module 108 and the secondary machine learning module 110 as being operated in parallel, one of ordinary skill in the art will understand that, in another embodiment, the modules are able to handle the data sequentially (e.g., the secondary machine learning module 110 receives data from the natural language processing module 108 or vice versa). In another embodiment, a single module performs the tasks of both the natural language processing module 108 and the secondary machine learning module 110 simultaneously.

In one embodiment, after the analyzed and/or section-delineated text data is fed into an assessment scale generator 112. In one embodiment, the assessment scale generator 112 automatically generates a percentage-based scale for assessing similarity between the user input credential and one or more other credentials. In one embodiment, the percentage-based scale for a particular type of credential (e.g., for syllabi, for course descriptions, for particular types of licenses, etc.), is normalized based on minimum similarity values with the corpus of similar documents received from the institution or field knowledge database 106. By way of example and not limitation, if all syllabi are determined to be at least 20% similar by the natural language processing module 108 (perhaps due to inherent similarities in the syllabus format), then 20% similarity is established as 0% similarity for the purposes of the percentage-based scale in order to provide more actionable data using the platform. In another embodiment, the percentage-based scale is not normalized. In one embodiment, percentage similarity is based on the percentage of the same or similar topics covered by each credential document while, in another embodiment, percentage similarity is based on the percentage of each document dedicated to topics common to both documents. In one embodiment, the secondary machine learning module 110 determines which measure of percentage similarity to use based on the corpus of similar documents.

In one embodiment, the scale generated by the assessment scale generator 112 is utilized by a feedback module 114 to provide feedback concerning the similarity between the text data related to the user provided credential and at least one other credential document. In one embodiment, the feedback module 114 receives a corpus of other, relevant credential documents and automatically generates similarity scores between the user provided credential and each of, or a subset of, the corpus of other, relevant credential documents. In one embodiment, the feedback provided by the feedback module 114 is presented as a list of other credential documents that are most related to the user input credential. In another embodiment, the feedback provided is a list of other credential documents with a similarity score provided for each of, or a subset of, the other credential documents. In yet another embodiment, the feedback provided identifies not only one similarity score for each analyzed document, but specific similarity scores for a plurality of sections or topic areas common to each document. In one embodiment, the feedback module 114 identifies one or more sections that are not common to each of the analyzed documents. In one embodiment, the feedback module 114 identifies one or more deficiencies of the user provided credential or document relative to a corpus of comparative credentials or documents. This is useful, for example, for detecting holes in an educational program relative to comparable programs at other institutions for identifying where is most important to improve.

In one embodiment, the secondary machine learning module 110 receives at least one criteria designating file from the credential holder 102 and/or the one or more institutions or field knowledge databases. In one embodiment, the criteria designating file includes a list of expected topics, sections, formatting, and/or other aspects of the credential. This provides guidance for the secondary machine learning module 110 as to how to divide received text files into sections, as the sections are able to be modeled on the expected sections or topics of the criteria designating file. Use of a criteria designating file is also useful for indicating to the secondary machine learning module 110 whether the received credential documents are deficient in some way or lacking in a particular section or topic, which is then able to be displayed to the user profile via the feedback module 114.

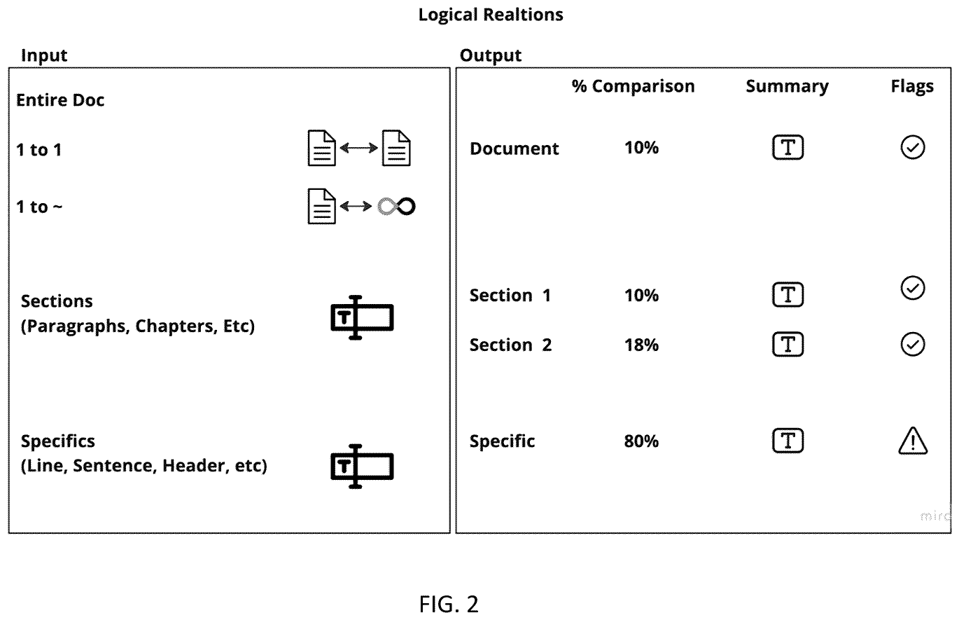

FIG. 2 illustrates an assessment page of a GUI for a system of comparing text data according to one embodiment of the present invention. An assessment page provides a summary of the similarity of a text file to one or more other text files. In one embodiment, a left column of the assessment page includes a description of which input is being evaluated and/or what specifically a corresponding similarity score positioned on the right of the assessment page is indicating. One of ordinary skill in the art will understand that the relative positioning of any elements on the assessment page are not intended to be limited to the configuration shown in FIG. 2 and are able to vary. Similarly, not all information shown on the assessment in FIG. 2 must necessarily be shown, nor is the information available on the assessment page limited to only that information shown in FIG. 2.

In one embodiment, the assessment page includes one or more values comparing the entirety of the text file to one or more other text files. In one embodiment, the assessment page includes different scores for comparing the text file to a single other document or for comparing the text file to a corpus of a plurality of text files. In one embodiment, the assessment page does not include a one-to-one comparison similarity score if a single text file to which to compare the input text file is not provided. In one embodiment, the assessment does not include a one-to-many comparison similarity score if only a single text file is provided and no corpus of a plurality of text files is identified. In one embodiment, the assessment page includes one or more values comparing one or more sections of the text file to one or more sections of one or more other text files. In one embodiment, the sections are simply given simple, indexing section names (e.g., Section 1, Section A, etc.). In another embodiment, at least one machine learning module automatically generates at least one section title (e.g., introduction, genetics discussion, requirements list, etc.) for each section based on semantic analysis of the at least one section. In one embodiment, the assessment page includes one or more values comparing one or more lines or paragraphs of the text file to one or more lines or paragraphs of one or more other text files. In one embodiment, the compared lines or paragraphs in the assessment page are ones specifically designated by the user profile for which the assessment page is generated. In another embodiment, the compared lines or paragraphs in the assessment page include all the lines or paragraphs, or a subset of lines or paragraphs not specifically designated by the user profile.

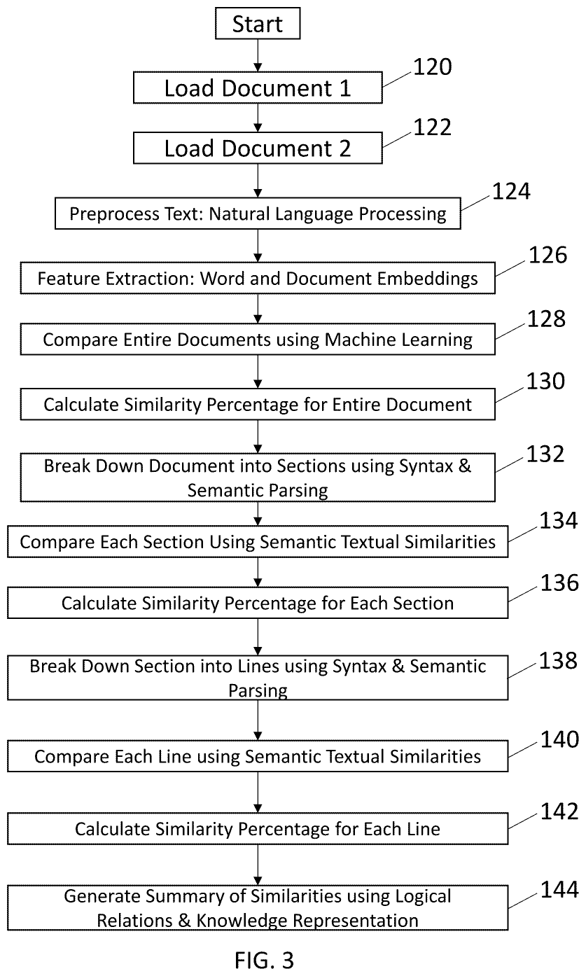

FIG. 3 illustrates a flow diagram for a system of comparing text data and sections of text data using machine learning according to one embodiment of the present invention. In one embodiment, a first data file is uploaded 120 by a user profile or retrieved from a web database through an application programming interface (API) and/or a software development kit (SDK) designed to read and recognize text files. In one embodiment, a second text file (or a plurality of additional text files) is then uploaded 122 through an API or SDK.

In one embodiment, the text in the text files is then preprocessed using natural language processing 124. The process is operable to include text normalization to convert text to uniform case and remove punctuation. Tokenization is also operable to be utilized to segment the text into discrete words and/or symbols. In step 124, the natural language processing is able to place the text from various different types of text files in a standard format, with punctuation removed, all letters put into lowercase, tokenizing sentences into individual words, and/or removing “stop words” (e.g., common words such as “and,” “the”, or “a”). Lemmatization is able to be used to consolidate different forms of a word to a base form for the word. In one embodiment, the platform then performs feature extraction 126 to create word and document embeddings, which are vector representations of words and of whole documents to help in capturing semantic meaning. In one embodiment, feature extraction 126 is able to be performed by any relevant algorithm known in the art, including but not limited to, word embedding algorithms (e.g., Word2Vec, Global Vectors for Word Representation (GloVe), etc.), document embedding algorithms (e.g., Doc2Vec), and/or advanced transformer models (e.g., Bidirectional Encoder Representation from Transformers (BERT), generative pre-trained transformer (GPT), etc.).

One or more machine learning algorithms are then able to compare 128 the preprocessed first text file and the preprocessed second text file (or plurality of second text files) to determine similarity between the documents. Based on this comparison, the platform generates at least one similarity score 130 for the entire document relative to one or more other documents. In one embodiment, the similarity score 130 is a percentage value, while, in other embodiments, the similarity score 130 is able to be represented with other numbers or with non-numerical indicators (e.g., color coding for similarity, letter scores, etc.).

In one embodiment, after generating a similarity score 130 for the entire document, a machine learning module automatically divides 132 the text file into a plurality of sections based on syntactic parsing, semantic parsing, and/or any other form of analysis of the text file. In other embodiments, the division of the text file into a plurality of sections occurs before or during the process of generating the similarity score 130 and thus one of ordinary skill in the art will understand that the present invention is not limited to performing the division step after the similarity comparison step 128 or the score generation step 130. The term “section” according to the present invention is able to mean one or more different concepts. In one embodiment, a section refers to a contiguous portion of a text file beginning at a first location and ending at a second location in the text file. In another embodiment, a section refers to one or more parts of a document that focus on the same semantic topic or theme, but which are not necessarily contiguous. The plurality of sections of the text file are then semantically compared 134 with one or more sections in one or more other text files. In one embodiment, the comparison 134 includes whether analogous sections are present in one or more other text files and/or the semantic similarity of one or more analogous sections in each text file. In one embodiment, based on the comparison 134 of the text files, the platform generates one or more section similarity scores 136, providing a value, alphanumeric indicator, or other indicator showing the similarity between sections of each text file. In one embodiment, the platform receives an input from a user device to evaluate similarity of a specific section of a document (e.g., abstract of a document), and generates a similarity score only for the designated section of the document. In another embodiment, the platform generates section similarity scores for all of the sections of the document. In one embodiment, the platform generates one section similarity score for each section while comparing the document to a single other document. In another embodiment, the platform generates a plurality of section similarity scores for each section, with each score indicating a similarity to one or more different documents (or different sets of documents). In yet another embodiment, the platform generates one section similarity score for each section, but where the section similarity score indicates similarity between each section and sections of a corpus of a plurality of documents.

In one embodiment, the platform further subdivides 138 a text file into separate paragraphs or lines. One of ordinary skill in the art will understand that this process is not limited to being performed after section similarity scores are generated for the text file, and that the system is also able to divide the text file into lines and/or paragraphs without first dividing the text file into sections at all. Furthermore, division of the text file into separate paragraphs or lines does not necessarily need to occur after comparison of the document as a whole and generation of at least one similarity score for the entire document. After the text file is subdivided into paragraphs or lines, the platform then semantically compares 140 the paragraphs or lines. The platform then generates one or more similarity scores 142 comparing the paragraphs or lines or one or more paragraphs or lines in one or more other text files. In one embodiment, the platform receives an input from a user device to evaluate similarity of a specific line or paragraph of a document (e.g., the final paragraph of the document), and generates a similarity score only for the designated line or paragraph of the document. In another embodiment, the platform generates line or paragraph similarity scores for all of the lines or paragraphs of the document. In one embodiment, the platform generates one line or paragraph similarity score for each line or paragraph while comparing the document to a single other document. In another embodiment, the platform generates a plurality of line or paragraph similarity scores for each line or paragraph, with each score indicating a similarity to one or more different documents (or different sets of documents). In yet another embodiment, the platform generates one line or paragraph similarity score for each line or paragraph, but where the line or paragraph similarity score indicates similarity between each line or paragraph and lines or paragraphs of a corpus of a plurality of documents. In still another document, the platform indicates specific lines or paragraphs that are exactly identical to one or more other lines or paragraphs in one or more other text files.

In one embodiment, the platform generates a summary 144 including each of the similarity scores generated for the text file, potentially including a similarity score for the entire document, similarity scores for one or more sections of the document, and/or similarity scores for one or more lines or paragraphs of the document.

In one embodiment, comparison of whole documents, individual sections, or subdivided lines or paragraphs is performed by at least one machine learning module. In one embodiment, the machine learning module uses cosine similarity on term frequency-inverse document frequency (TF-IDF) vectors generated for the text file in order to evaluate similarity. In this embodiment, the similarity score is able to be calculated based on the cosine of the angle between two document vectors, which is then translated to a percentage value. However, one of ordinary skill in the art will understand that the algorithms utilized by the machine learning module for document comparison are not intended to be limiting according to the present invention.

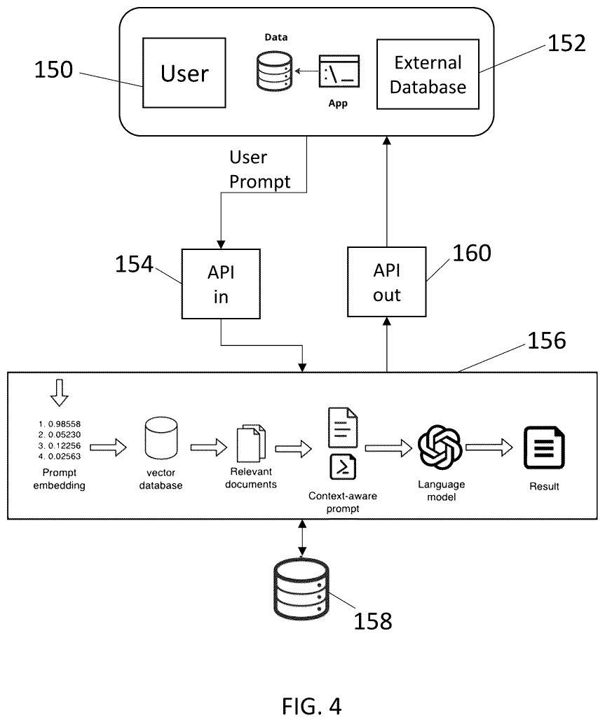

FIG. 4 illustrates a schematic diagram for a system receiving a user prompt and semantically evaluating the document in comparison to a database of related documents according to one embodiment of the present invention. In one embodiment, the platform receives a user prompt and/or one or more text files from at least one user profile 150. In one embodiment, the platform further receives at least one comparison text file, one or more criteria designating files, and/or a corpus of a plurality of documents from the user profile 150 or from at least one external database 152. In one embodiment, the user prompt, the at least one text file, the at least one comparison text file, the one or more criteria designating files, and/or a corpus of a plurality of documents from the user profile are retrieving by the platform by at least one API 154.

In one embodiment, after receiving the information from the user profile 150 and/or the external database 152, the server 156 performs a series of analysis steps for processing and evaluating the at least one text file to generate a result (e.g., one or more similarity scores). In one embodiment, the received files and/or the generated results are stored in at least one database 158 associated with the sever 156. In one embodiment, the generated results are then able to be provided and displayed to the user profile via at least one API 160.

Importantly, the present invention is adaptable across different domains, tailoring the scoring algorithms to specific sectors and applications. Scoring algorithms are operable to be automatically updated in real time or near real time based on domain-specific data, insights, or observations identified using the steps or components of the present invention. The present invention is able to be used to improve operations in a variety of fields, with emphasis on different types of documents, as is outlined in further detail below.

### Education

The text analysis and comparison tool is able to be used in the education sector by leveraging detailed similarity evaluations at various text granularity levels-ranging from entire documents to specific sections, paragraphs, and lines. The approach, using advanced machine learning techniques such as cosine similarity on TF-IDF vectors, ensures precise evaluations crucial for facilitating seamless credit transfers, curriculum development, and academic recognition.

The tool provides for transfer of credentials, grades, and coursework across various educational institutions, including both public and private institutions. By leveraging the capability to generate detailed similarity scores for individual document sections, the tool ensures students receive due credit for previous academic experience and simplifies the admission processes into higher education.

In higher education, the tool provides for cross-comparison of courses, syllabi, degrees, and certifications across colleges and universities. The tool evaluates the overall similarity between diverse educational offerings and analyzes the nuances of course content, learning outcomes, and assessment criteria. This allows educational institutions to recognize and credit equivalent coursework accurately, fostering a more interconnected and flexible higher education system.

For professionals seeking career advancement through continuing education, the tool provides support by comparing and validating continuing education credentials. The tool analyzes continuing education documents across various institutions and programs to validate their relevance and equivalence, allowing professionals to have recognition of maintenance and expansion of expertise. In one embodiment, the present invention provides a certification of continuing education content, such as a lecture, a course, a conference, or any other form of continuing education as meeting a certain standard.

As online education continues to expand, the tool addresses the challenge of ensuring the equivalency of online courses and certifications with traditional education systems. The tool scrutinizes the content, learning objectives, and assessment methods of online offerings, effectively comparing these with traditional counterparts to ensure the online offerings meet established standards of educational quality and relevance.

The system includes a graphical user interface operable to receive uploaded documents for similarity comparisons, which supports both direct one-to-one document comparisons and broader comparisons against a corpus of documents stored in a database. Results are displayed in intuitive formats such as percentages for easy interpretation, facilitating quick decision-making by educational administrators and advisors.

Types of texts able to be analyzed by the tool with respect to education applications include, but are not limited to, transcripts, report cards, course syllabi, course descriptions, degree certificates, online lecture notes, accreditation certificates, continuing education certificates, admission applications, standardized test score spreadsheets, curriculum development plans, educational policy documents, teacher certification documents, educational grant proposals, scholarship applications, student essays and assignment descriptions, multimedia educational content (e.g., slide decks, videos, etc.), educational conference materials, professional development workshop materials, course feedback form, academic journal publications, and/or other types of documents.

By integrating inter-institutional text analysis and comparison tool into the education sector, the present invention enhances management of credit transfers, curriculum development, and the validation of educational credentials. This tool not only streamlines academic administrative processes but also supports the advisory and enrollment management functions, leading to a more interconnected and flexible educational landscape where students are able to transition smoothly between institutions and programs, thus broadening their academic and professional opportunities. This results in a more dynamic educational environment that is adaptive and efficient.

### Government Business

The inter-institutional text analysis and comparison tool facilitates government operations across various functions by providing robust mechanisms for analyzing and comparing a wide array of documents. With capabilities to perform detailed similarity evaluations at various levels of text granularity, from entire documents to specific sections, the present invention ensures precise evaluations, crucial for improving efficiency, ensuring compliance, and enhancing inter-agency cooperation.

The tool improves the patent examination process by automating the comparison of new patent applications against databases of existing patents and public disclosures. This speeds up the process, allowing examiners to efficiently determine the novelty and non-obviousness of inventions, reducing backlog, and enhancing the integrity of the patent system.

For the USPTO, the tool streamlines operations by automating the comparison of text across patent and trademark applications, significantly reducing the manual effort required to identify similarities or unique claims. This supports the professional judgment of examiners, increasing accuracy and decreasing the time to reach allowance, or facilitating and supporting rejections of applications based on prior art or prior registered/filed applications. In one example, the tool is used to analyze claims of a patent application and to identify prior art, including patent prior art and non-patent literature, which may be cited in prior art rejections for the application. The too is also operable to be utilized to compare claims of a patent application to claims of other applications or patents to identify instances in which a non-statutory or statutory double patenting rejection should be instituted. Additionally, the tool is operable to compare claims of a patent application to claims of other applications or patents which were rejected under 35 USC 101 on the basis of allegedly not being directed to patent eligible subject matter to identify if the claims of the patent application should be rejected under 35 USC 101. For trademark applications, the tool is operable to compare both the applied for trademark and the description of goods/services to prior registered US trademarks and pending prior-filed US trademark applications.

The tool is also operable to be used by attorneys, agents, and applicants to identify relevant prior art for patent applications or potential patent applications, potential instances of statutory or non-statutory double patenting for claims of patent applications or potential patent applications, and potential 35 USC 101 rejections based on comparisons to prior filed patents, applications, or other documents. Similarly, the tool is operable to be utilized by trademark applicants or attorneys to identify potentially confusingly similar trademark registrations or prior-filed applications for an existing or potential trademark application.

For the immigration process, the tool simplifies the complex task of comparing educational and professional credentials across international boundaries. The present invention provides for the analysis and comparison of documents related to education and professional experience, offering detailed similarity scores that enable authorities and applicants to accurately assess the equivalency of qualifications obtained abroad.

In public safety, the technology automates the verification of certifications for first responders, ensuring that police officers, firefighters, and EMS personnel meet the requisite training and certification standards. This enhances the reliability of public safety services by confirming that all personnel are qualified to respond effectively in emergencies.

The tool also automates the comparison and verification of credentials for individuals requiring security clearance, enhancing the security clearance process by ensuring that only suitably qualified individuals are granted access to sensitive information.

The tool facilitates efficient information exchange between government agencies, both domestically and internationally. By providing a platform for the automated comparison and verification of documents, the tool ensures that agencies are able to share and validate credentials quickly and accurately, enhancing collaboration and operational efficiency.

Types of texts operable to be analyzed by the tool with respect to government applications include, but are not limited to, patent applications, issued patents, trademark documents including trademark applications, registrations, and associated USPTO correspondence, educational and professional credentials, certification documents for first responders, security clearance documents, inter-agency reports, legislative documents, regulatory compliance documents, public safety protocols and guidelines, government contracts, environmental impact assessments, immigration forms and applications, public health records, voter registration data, financial audit reports, transportation safety documents, urban planning documents, military personnel records, judicial case files, and/or census data.

The integration of the inter-institutional text analysis and comparison tool within various government sectors not only streamlines the examination of patents and the processing of intellectual property but also supports critical functions in immigration, public safety, and security clearances. The tool optimizes efficiency, enhances accuracy, and provides for a connected government infrastructure, crucial for adapting to the demands of a rapidly evolving global and digital landscape. By improving the management and protection of intellectual property, ensuring the qualifications of individuals in sensitive roles, and facilitating secure interagency cooperation, the technology assists in modernizing government operations.

### Regulatory Compliance

The inter-institutional text analysis and comparison tool is able to be used for real estate applications by providing robust mechanisms for analyzing and comparing a wide array of property documentation and legal documents across various real estate functions. With capabilities to perform detailed similarity evaluations at various levels of text granularity, from entire documents to specific sections, the present invention provides for precise evaluations, crucial for improving property documentation management, legal compliance, and market analysis.

The tool enhances the management and comparison of property documentation, ensuring that descriptions and legal documents are accurate and compliant with industry standards. By generating detailed similarity scores for individual sections, the tool ensures precise validations crucial for property transactions and management.

The present invention improves the way property listings are managed by automating the comparison of property descriptions with existing listings and regulatory requirements. This functionality allows real estate agents and property managers to ensure that listings are accurately described and meet legal standards, preventing misrepresentations and potential legal disputes.

The tool assists in the analysis and comparison of legal documents such as contracts, lease agreements, and deeds. This ensures that all legal documents reflect the terms agreed upon and comply with local real estate laws, facilitating smooth and lawful property transactions.

The tool plays an important role in property valuation and market analysis by enabling the comparison of property features and market data. This helps real estate professionals and investors make informed decisions based on accurate market comparisons and trend analysis.

The tool assists real estate companies in complying with industry regulations by comparing operational documents and policies against regulatory standards. This ensures that real estate practices are not only effective but also fully compliant with legal requirements.

The tool supports the comparison and transfer of real estate licenses across states or countries, and enables real estate professionals to easily understand the equivalency of qualifications in different jurisdictions, aiding in geographic expansion of practices and supporting regulatory bodies in maintaining standards across the industry.

Types of texts able to be analyzed by the tool with respect to government applications include, but are not limited to, compliance policies, audit reports, regulatory filings, internal review documents, risk management reports, training records, environmental compliance documents, data privacy agreements, health and safety reports, legal notices, corporate governance records, licenses and permits, anti-money laundering (AML) policies, ethics code compliance, contract compliance documents, customer consent forms, supplier compliance agreements, financial controls documentation, insurance compliance certificates, and/or cross-border compliance documents.

Integrating the inter-institutional text analysis and comparison tool into real estate-related matters therefore not only optimizes the management of property listings and legal documents but also supports market analysis and regulatory compliance. This fosters a more reliable, transparent, and efficient real estate market, where transactions are conducted with higher accuracy and compliance, benefiting all parties involved in the real estate industry.

### Legal

The inter-institutional text analysis and comparison tool also facilitates improved legal operations by providing robust mechanisms for analyzing and comparing a wide array of legal documents across various functions. With capabilities to perform detailed similarity evaluations at various levels of text granularity, from entire documents to specific sections, the present invention ensures precise evaluations, crucial for improving the accuracy and efficiency of legal processes.

The tool enhances the accuracy and efficiency of intellectual property (IP) management and contract analysis by segmenting and comparing legal documents. The tool generates detailed similarity scores for individual sections of legal documents, ensuring precise comparisons and in-depth evaluations of terms, claims, and stipulations.

In the domain of intellectual property specifically, the tool streamlines the examination and comparison process. The tool divides patents into specific sections, assesses overall similarity compared to other patents, and examines detailed claims and descriptions, facilitating the identification of potential infringement and enhancing IP management accuracy. For contract law, the tool automates the comparison of contract clauses and terms across different documents. The tool provides legal professionals with tools to conduct thorough reviews, quickly pinpoint areas of concern, and ensure compliance with applicable laws. The tool assists in litigation by providing detailed comparisons of legal documents pertinent to cases, aiding legal professionals in building stronger cases based on concrete textual analysis.

The technology assists organizations in comparing policies and procedures with legal standards and regulations, ensuring that operational practices are up-to-date and compliant with legal requirements. The tool supports the legal sector in comparing and validating licenses across different jurisdictions for lawyers and paralegals and evaluates the specifics of legal education, professional experience, and ethical standards required in different regions, facilitating the recognition of equivalencies and qualifications, and streamlining the credentialing process for legal professionals.

The tool assists in the comparison of regulatory documents to ensure compliance across jurisdictions. The tool meticulously compares sections of regulatory documents, identifying similarities and discrepancies with the precision needed to navigate the nuanced landscape of legal compliance.

Types of texts able to be analyzed by the tool with respect to government applications include, but are not limited to, legal contracts, court filings, patent documents, trademark documents, litigation documents, regulatory compliance documents, legal opinions, corporate legal policies, other corporate procedures and policies such as operating manuals and handbooks, lease agreements, employment agreements, licensing agreements, privacy policies, legal research papers, real estate deeds, wills, trust-related documents, divorce filings, bankruptcy filings, arbitration documents, environmental law documents, an/or international law documents.

By integrating the inter-institutional text analysis and comparison tool into the legal sector, organizations are able to enhance their legal operations across various domains, from intellectual property and contract management to compliance and litigation. This not only improves legal outcomes but also increase the efficiency of legal processes, ensuring that legal professionals are able to focus on strategic decision-making and client advocacy. The tool therefore supports the mobility and adaptability of the legal profession.

### Healthcare

The inter-institutional text analysis and comparison tool improves the healthcare sector by providing mechanisms for analyzing and comparing a wide array of medical documents across various healthcare functions. With capabilities to perform detailed similarity evaluations at various levels of text granularity, from entire documents to specific sections, the present invention provides for precise evaluations, crucial for improving credentialing processes, patient safety, and regulatory compliance.

The tool streamlines healthcare credentialing and facilitates detailed comparisons of medical records across different institutions. The tool generates detailed similarity scores for individual document sections, increasing the precision of verifications and comparisons essential in healthcare settings. The present invention automates the process of verifying the qualifications of healthcare professionals, such as doctors, nurses, and allied health workers. By comparing credentials against standardized requirements and accreditations, the tool ensures that all healthcare staff meet necessary professional standards, thereby safeguarding patient care quality. The present invention also improves patient safety by comparing medical records across different healthcare systems. The tool ensures continuity and accuracy in medical histories and treatment plans, critical for identifying potential medication conflicts, duplications in testing, or variations in treatment approaches.

The present invention aids medical researchers and compliance officers by analyzing and comparing clinical study reports and compliance documents, provides insights into data consistency and research validity, and ensures that healthcare practices and procedures align with regulatory standards. The tool further enhances health data interoperability by standardizing and comparing health information across different electronic health record systems. This supports the seamless exchange of patient data among providers, improving the efficiency of healthcare delivery and enabling more personalized and timely medical care. The present invention streamlines the credentialing process for healthcare professionals moving or practicing across states or countries. By conducting detailed comparisons of healthcare credentials, the tool identifies the equivalency of qualifications with precision, facilitating a smoother transition for healthcare workers into new jurisdictions.

The present invention supports the comparison of medical licenses and certifications across different jurisdictions, addressing the challenges medical professionals face when practicing in new areas. By generating detailed similarity scores for individual sections of medical credentials, the tool aids regulatory bodies and medical professionals in understanding the equivalencies and differences between jurisdictions.

Types of texts able to be analyzed by the tool with respect to government applications include, but are not limited to, medical records, credentialing documents, clinical study reports, patient safety reports, pharmaceutical patents, healthcare policies, insurance claims, compliance documentation, medical device documentation, treatment protocols, surgical consent forms, immunization records, lab test results, epidemiological studies, nutritional studies, health informatics data, pharmacy prescriptions, mental health records, emergency response plans, and/or bioethics documents.

By integrating the inter-institutional text analysis and comparison tool into the healthcare sector, the present invention not only streamlines administrative processes like credentialing and medical record management but also directly contributes to improved patient care outcomes. The tool increases the efficiency of healthcare operations, enhances patient safety, and supports the mobility of healthcare professionals.

### Research Institutions

The inter-institutional text analysis and comparison tool significantly also benefits research institutions by providing robust mechanisms for streamlining literature reviews and facilitating detailed comparisons of research papers. With capabilities to perform detailed similarity evaluations at various levels of text granularity, from entire articles to specific sections, the present invention allows for precise and thorough evaluations, crucial for advancing academic research and ensuring integrity.

The present invention enhances the efficiency and depth of literature reviews by automating the comparison of research papers and articles for overlapping content or findings. The tool is equipped to generate detailed similarity scores for individual sections, and ensures precise evaluations essential for identifying relevant studies and distinguishing unique contributions.

The tool improves the way literature reviews are conducted by automating the comparison of research articles against a vast database of published works. This allows researchers to quickly identify relevant studies, review overlapping findings, and ensure that their own work is innovative and well-informed. The system of the present invention assists in fostering collaboration among researchers by identifying areas of common interest and complementary findings, with researchers being able to use the tool to find potential collaborators whose work aligns closely with their own, enhancing the potential for joint projects and multi-disciplinary studies.

The present invention will play an important role in maintaining research integrity by ensuring that new research papers are original and properly cite previous work. This prevents unintentional plagiarism and reinforces ethical standards in academic research. The tool also supports researchers in preparing grant applications and publication submissions by ensuring their proposed studies or findings significantly add to the existing body of knowledge. Researchers are able to utilize the tool to highlight the novel aspects of their work, enhancing their chances of receiving funding and acceptance for publication.

Types of texts able to be analyzed by the tool with respect to government applications include, but are not limited to, research papers, literature reviews, grant proposals, ethics approval documents, experimental protocols, data sets, patent applications, conference papers and proceedings, theses and dissertations, research collaboration agreements, peer review feedback, regulatory compliance documents, research funding agreements, publication agreements, laboratory notebooks, research impact assessments, data management plans, intellectual property rights documents, project progress reports, and/or post-research evaluation reports.

Integrating the inter-institutional text analysis and comparison tool into research institutions therefore not only optimizes the literature review process, but also supports the broader goals of academic research, including collaboration, originality, and integrity. By providing a robust platform for detailed document comparison and evaluation, the tool empowers researchers to produce high-quality, impactful research that advances knowledge and fosters innovation across disciplines.

### Information Technology (IT)

The inter-institutional text analysis and comparison tool is able to be used for Information Technology (IT) departments in providing robust mechanisms for analyzing and comparing a wide array of IT documents and certifications. With capabilities to perform detailed similarity evaluations at various levels of text granularity, from entire documents to specific sections, the system ensures precise evaluations, crucial for maintaining high standards in IT operations and compliance.

The tool streamlines the management of software documentation and facilitates the validation of IT certifications across various certifying bodies. The system is able to generate detailed similarity scores for individual sections of documents, helping to provide precise analysis and comparisons for maintaining high standards in IT operations.

In software development, managing and comparing documentation is crucial for ensuring consistency and accuracy across different versions and products. The tool automates the comparison of software documentation, allowing developers and project managers to quickly identify discrepancies or changes between versions. This capability is particularly valuable in large-scale projects where documentation is extensive and subject to frequent updates.

The tool allows for the validation of IT certifications by facilitating the comparison of certification credentials against industry standards and job requirements. This helps HR departments and hiring managers verify the qualifications of potential hires and existing employees. The tool also aids IT companies in complying with industry regulations by comparing their policies, procedures, and documentation against regulatory requirements. This feature is particularly important for companies dealing with sensitive information, where compliance with data protection and privacy standards is mandatory.

The present invention is able to support IT education and training providers by analyzing and comparing educational content and certification curricula. This allows for the alignment of training programs with industry standards and emerging technological trends, ensuring that learners are receiving relevant and high-quality education that meets the demands of the IT market. The tool also allows for validating and comparing certifications and credentials across various certifying bodies in the Technology and IT sectors. The tool analyzes and compares the specific sections of IT certifications and credentials, ensuring a comprehensive understanding of the competencies covered, enabling the recognition of equivalencies and skill gaps across different certifying bodies.

Types of texts able to be analyzed by the tool with respect to government applications include, but are not limited to, software documentation, IT certification documents, user manuals, compliance reports, project specifications, network security policies, application programming interface (API) documentation, system configuration files, audit trail records, bug reports, training materials, service level agreements (SLAs), incident response plans, source code files, technology patents, data privacy agreements, cloud configuration documents, cybersecurity incident reports, end-user license agreements (EULAs), and/or product development roadmaps.

Therefore, incorporating the inter-institutional text analysis and comparison tool into IT-related applications not only optimizes document management and certification validation but also supports regulatory compliance and educational alignment. This provides a more informed, compliant, adaptable, and capable IT workforce.

### Financial Services

The inter-institutional text analysis and comparison tool is also able to be used in financial services for analyzing and comparing a wide array of financial documents across various functions. With capabilities to perform detailed similarity evaluations at various levels of text granularity, from entire documents to specific sections, this present invention ensures precise evaluations, crucial for improving due diligence, compliance, risk assessments, and financial innovation.

The tool streamlines the analysis and comparison of financial documents, such as contracts, reports, and compliance filings. The tool utilizes its capability to generate detailed similarity scores for individual sections, ensuring accurate and efficient evaluations for risk management and regulatory compliance. The tool also improves due diligence in financial transactions by automating the comparison of financial documents against established benchmarks and historical data. This allows financial analysts and auditors to quickly identify discrepancies, risks, and anomalies, uncovering potential financial misstatements or undisclosed liabilities. This assists financial institutions in ensuring their operations and reporting align with legal requirements. By automating the comparison of compliance documents against regulatory frameworks, the tool identifies areas where compliance is potentially lacking, facilitating timely corrections and adjustments. The present invention is able to play an important role in risk management by analyzing and comparing financial documents related to credit, market, and operational risks. The tool enables risk managers to assess the alignment of risk management strategies with actual practices and detect early signs of potential risks.

The tool is also able to support innovation in financial products and services by allowing institutions to analyze and compare new financial products with existing offerings. This aids in ensuring that new products are competitive, compliant, and meet market needs while maintaining the institution's risk profile. The tool is also able to support the comparison of professional certifications with regard to banking and finance across different regions. With financial regulations and required certifications varying widely across jurisdictions, the system ensures that professionals' certifications are accurately compared and validated, assisting financial institutions in meeting local and international regulatory requirements.

Types of texts able to be analyzed by the tool with respect to government applications include, but are not limited to, financial statements, loan applications, audit reports, regulatory compliance documents, bank transaction records, credit reports, investment portfolios, risk assessment documents, insurance policies, due diligence reports, mortgage documents, bond prospectuses, mutual fund prospectuses, hedge fund strategies, market analysis reports, anti-money laundering (AML) policies, know your customer (KYC) documents, derivative contracts, financial planning documents, and/or equity research reports.

Integrating the inter-institutional text analysis and comparison tool into financial services operations not only optimizes financial document management and risk assessment processes but also enhances regulatory compliance and supports financial innovation. This leads to more informed decision-making, improved financial stability, and enhanced compliance, positioning financial institutions to better navigate the complexities of the modern financial landscape.

### Insurance

The inter-institutional text analysis and comparison tool has particular application to insurance, providing robust mechanisms for analyzing and comparing insurance claims documents. With capabilities to perform detailed similarity evaluations at various levels of text granularity, from entire documents to specific sections, the system provides for precise evaluations, important for improving claims processing, fraud detection, risk management, and regulatory compliance.

The tool increases the precision and efficiency of insurance claims processing by automating the comparison of claims documents to identify fraudulent or duplicate claims based on textual similarities. This allows for accurate assessment of which claims are legitimate, thereby speeding up the claims processing time and improving customer satisfaction.

The present system specifically improves the way insurance claims are processed by automating the comparison of submitted claims against a database of past claims and known fraud patterns. This functionality allows claims adjusters to quickly identify potential fraud, duplication, or inconsistencies in claims submissions.

Importantly, the present invention is able to provide analytics for detecting patterns and anomalies that indicate fraudulent activity. By automating the analysis of textual content in claims documents, the tool helps uncover hidden relationships and inconsistencies that human reviewers often overlook. The tool therefore improves risk management by analyzing claims over time to identify trends that indicate emerging risks or vulnerabilities within the insurance portfolio. This enables insurers to adjust their policies and coverage to better manage risk and prevent future losses. The system also aids insurance companies in complying with industry regulations by ensuring that all claims processing is done in a transparent and consistent manner. By maintaining detailed records of claims analysis and comparisons, insurance companies are able to demonstrate compliance with regulatory standards and audits.

Types of texts able to be analyzed by the tool with respect to government applications include, but are not limited to, insurance policy documents, claims forms, adjuster reports, fraud investigation reports, risk assessment reports, underwriting documents, reinsurance contracts, settlement documents, actuarial reports, regulatory compliance reports, customer communication records, policy renewal documents, health insurance records, vehicle insurance records, property damage assessments, life insurance agreements, legal documents related to claims, premium payment records, insurance marketing materials, and/or audit documentation.

Integrating the inter-institutional text analysis and comparison tool into insurance-related applications not only optimizes claims processing and fraud detection but also supports risk management and regulatory compliance. This leads to more efficient operations, reduced financial risks, and improved customer trust, positioning insurance companies to better serve their clients and succeed in a competitive market.

### Real Estate

The inter-institutional text analysis and comparison tool improves real estate transactions by providing robust mechanisms for analyzing and comparing a wide array of property documentation and legal documents across various real estate functions. With capabilities to perform detailed similarity evaluations at various levels of text granularity, from entire documents to specific sections, the system ensures precise evaluations, crucial for improving property documentation management, legal compliance, and market analysis.

The tool enhances the management and comparison of property documentation, ensuring that descriptions and legal documents are accurate and compliant with industry standards. By generating detailed similarity scores for individual sections, this tool ensures precise validations crucial for property transactions and management. The tool improves the way property listings are managed by automating the comparison of property descriptions with existing listings and regulatory requirements. This functionality allows real estate agents and property managers to ensure that all listings are accurately described and meet legal standards, preventing misrepresentations and potential legal disputes.

The present invention assists in the analysis and comparison of legal documents such as contracts, lease agreements, and deeds. This ensures that all legal documents reflect the terms agreed upon and comply with local real estate laws, facilitating smooth and lawful property transactions.

It also plays a role in property valuation and market analysis by enabling the comparison of property features and market data. This helps real estate professionals and investors make informed decisions based on accurate market comparisons and trend analysis. Furthermore, the tool assists real estate companies in complying with industry regulations by comparing operational documents and policies against regulatory standards. This ensures that real estate practices are not only effective but also fully compliant with legal requirements. Additionally, by supporting the comparison and transfer of real estate licenses across states or countries, the tool enables real estate professionals to easily understand the equivalency of their qualifications in different jurisdictions, aiding in geographic expansion of their practice and supporting regulatory bodies in maintaining standards across the industry.

Types of texts able to be analyzed by the tool with respect to government applications include, but are not limited to, property listings, real estate contracts, title documents, mortgage agreements, lease agreements, property appraisals, building permits, zoning regulations, environmental impact assessments, property management agreements, property tax records, home inspection records, commercial development plans, real estate market analysis reports, homeowners association (HOA) documents, foreclosure documents, property insurance policies, escrow agreements, land survey records, tenant background checks, and/or other documents.

The use of the inter-institutional text analysis and comparison tool in real estate transactions not only optimizes the management of property listings and legal documents but also supports market analysis and regulatory compliance. This fosters a more reliable, transparent, and efficient real estate market, where transactions are conducted with higher accuracy and compliance, benefiting each party involved in the real estate industry.

### Construction and Trades

The inter-institutional text analysis and comparison tool improves construction and trades by providing robust mechanisms for analyzing and comparing a wide array of certifications and documentation related to skilled trades. With capabilities to perform detailed similarity evaluations at various levels of text granularity, from entire documents to specific sections, the tool ensures precise evaluations, which are important for improving certification validation, safety compliance, and workforce management.

The tool streamlines the validation of trade certifications for electricians, plumbers, and other skilled tradespeople across jurisdictions. By leveraging advanced capabilities to generate detailed similarity scores for individual sections of certification documents, the system ensures precise evaluations crucial for maintaining high standards in trade qualifications and safety. This assists in ensuring that individuals working in critical infrastructure and construction projects meet the requisite skills and safety standards, and not only fosters trust within the industry, but also enhances compliance with regulatory safety requirements, crucial for preventing accidents and ensuring quality workmanship. By verifying the skills and certifications of tradespeople, the system ensures that all personnel on a construction site are properly qualified, which is essential for effective project execution and adherence to industry standards. The tool also facilitates continuous education and training for tradespeople by comparing educational content and training programs against industry requirements, ensuring that training programs are up-to-date and relevant, helping tradespeople maintain their skills in a rapidly evolving industry. Supporting the mobility of tradespeople across jurisdictions by providing a reliable platform for the comparison and recognition of professional qualifications aids tradespeople in expanding their practice geographically and supports regulatory bodies in maintaining standards across the industry.

The system also improves the way project documentation is managed by automating the comparison of project specifications, blueprints, and compliance documents with existing standards and regulations. This functionality allows project managers and site supervisors to quickly identify discrepancies or gaps in compliance, ensuring that all aspects of a construction project align with legal and safety standards.

Types of texts able to be analyzed by the tool with respect to government applications include, but are not limited to, building permits, construction project plans, safety compliance documents, trade certifications, blueprints and schematics, material safety data sheets (MSDS), inspection reports, workforce training materials, project bidding documents, change orders, equipment manuals, labor agreements, quality assurance reports, environmental impact statements, construction budgets, subcontractor agreements, compliance certifications, warranty documents, incident and accident reports, and/or completion certificates.

Applying the inter-institutional text analysis and comparison tool to construction and trade businesses allows organizations and regulatory bodies to optimize the management of certifications, project documentation, and workforce skills. This not only enhances the precision and efficiency of validation processes but also supports safety compliance and continuous education within the industry. By providing a robust platform for detailed document comparison and verification, the tool ensures that construction and trade professionals are able to operate with enhanced accuracy, compliance, and efficiency, ultimately supporting the overarching goal of improved project outcomes and workforce mobility.

### Sports and Athletics

The inter-institutional text analysis and comparison tool also provides benefit to sports and athletics by providing robust mechanisms for analyzing and comparing a wide array of certifications and qualifications related to coaching and athlete performance. With capabilities to perform detailed similarity evaluations at various levels of text granularity, from entire documents to specific sections, the system ensures precise evaluations, which are important for improving the validation of coaching certifications and athlete qualifications across regions.

The tool streamlines the process of comparing and validating coaching certifications and athlete qualifications across regions by leveraging capabilities to generate detailed similarity scores for individual sections of documents. The tool assists sports organizations in ensuring that coaching staff and athletes meet the required qualifications and standards, which is essential for fostering fair play and maintaining the integrity and safety of sports practices. This not only enhances the competitiveness of sports teams but also ensures compliance with international sports regulations. This improves the way athlete registrations and credential verifications are managed by automating the comparison of athlete records and qualifications with sporting body requirements. This functionality allows sports federations and associations to quickly identify discrepancies or gaps in athlete qualifications, ensuring that all participants are eligible and adequately prepared for competition. Therefore, the tool supports the enforcement of fair competition rules and adherence to sportsmanship principles by enabling detailed comparisons of compliance documents and competition records. This helps ensure that all participating teams and individuals adhere to the rules, promoting a culture of fairness and respect in sports.

The present invention is also able to help in analyzing and comparing training programs against best practices and evolving sports science research. This capability ensures that training regimens are scientifically sound and aligned with the latest advancements in athletic training, contributing to improved athlete performance and injury prevention. Additionally, the tool helps global talent scouting efforts and recruitment by providing sports organizations with the tools to compare and validate the skills and qualifications of potential recruits from different regions, aiding in the discovery of emerging talents and ensures that recruitment decisions are based on reliable and comparable data.

Types of texts able to be analyzed by the tool with respect to government applications include, but are not limited to, coaching certifications, athlete qualification records, sporting event rules and regulations, training program materials, doping control documents, player contracts, match reports, fitness assessment reports, nutritional guidelines, equipment compliance certificates, injury reports, game strategy documents, referee and official certifications, league and tournament records, sports medicine protocols, team rosters, venue safety certifications, fan engagement plans, sponsorship agreements, and/or broadcast rights contracts.

By integrating the inter-institutional text analysis and comparison tool into these sports and athletics applications, organizations are able to optimize the management of coaching certifications and athlete qualifications. The tool not only enhances the precision and efficiency of validation processes but also supports the integrity and safety of sports practices, fostering fair play and excellence in sports globally. By providing a robust platform for detailed document comparison and verification, the tool ensures that sports and athletics organizations operate with improved accuracy, compliance, and efficiency, ultimately supporting the overarching goal of improving sports management.

### E-Commerce

The inter-institutional text analysis and comparison tool has application in e-commerce by providing robust mechanisms for analyzing and comparing product descriptions across different online marketplaces. With capabilities to perform detailed similarity evaluations at various levels of text granularity, from entire descriptions to specific sections, the system allows for precise evaluations, important for maintaining brand integrity, consistency, and compliance with brand guidelines.

The tool improves the accuracy and consistency of product listings across various online platforms by automating the comparison of product descriptions to ensure compliance with brand guidelines. This improves the management of product listings by automating the comparison of product descriptions against a set standard or brand guidelines, allowing commerce managers and content creators to quickly identify inconsistencies or deviations from brand messaging across multiple platforms. The system is able to assist online retailers by providing advanced analytics to ensure that product descriptions are not only consistent with brand guidelines but also optimized for search engines (SEO). The tool automates the analysis of keyword usage, meta descriptions, and other SEO factors, facilitating effective content strategies. This allows businesses to maintain a unified brand voice and content strategy across all online sales channels, and ensures that product descriptions and branding are uniform, critical for customer recognition and satisfaction.

The system also aids e-commerce companies in complying with industry regulations related to advertising and product descriptions. By ensuring that all product listings are accurate and do not make unsubstantiated claims, companies are better able to avoid legal issues and maintain good standing with regulatory bodies.

Types of texts able to be analyzed by the tool with respect to government applications include, but are not limited to, product descriptions, customer reviews, pricing strategies, brand guidelines, marketplace compliance documents, inventory records, sales reports, promotional materials, supplier contracts, shipping policies, return and refund policies, customer service communications, digital marketing campaigns, SEO performance reports, user interface designs, privacy policies, payment gateway agreements, fraud prevention protocols, competitor analysis reports, and/or legal compliance documents.

By Integrating the inter-institutional text analysis and comparison tool into e-commerce, users are not only able to optimize the management of product listings but also enhance the quality and consistency of online content. This leads to improved consumer trust, better compliance with SEO and regulatory standards, and ultimately, increased sales and brand loyalty, positioning e-commerce businesses for success in a highly competitive online marketplace.

### Customer Service

The inter-institutional text analysis and comparison tool helps customer service by providing robust mechanisms for analyzing and comparing customer service interactions. With capabilities to perform detailed similarity evaluations at various levels of text granularity, from entire conversations to specific sections, the system ensures precise evaluations, crucial for improving service quality, training, and regulatory compliance.

The tool enhances the management and analysis of customer inquiries, feedback, and responses to improve service quality and training and is capable of generating detailed similarity scores for individual sections, providing precise evaluations important for optimizing customer service strategies and enhancing customer satisfaction. This helps improve the way customer interactions are managed by automating the comparison of customer inquiries, feedback, and service responses against best practices and previously resolved cases, and allows customer service managers and representatives to quickly identify trends, recurring issues, or anomalies in customer interactions. This data-driven approach identifies areas where representatives excel or need improvement, ensuring that all team members are well-equipped to handle customer interactions proficiently.

The system also plays a role in personalizing customer service by analyzing specific needs and histories of customers. By comparing current inquiries with historical data, service teams are able to better tailor their responses to meet individual customer preferences and previous interactions. Finally, the tool aids in compliance and feedback management by ensuring that all customer interactions are conducted within the guidelines of industry regulations and company policies, and systematically gathers and analyzes customer feedback to drive improvements and innovations in service offerings.

Types of texts able to be analyzed by the tool with respect to government applications include, but are not limited to, customer inquiry logs, feedback forms, service interaction transcripts, complaint resolutions, training manuals, quality assurance reports, customer satisfaction surveys, service level agreements (SLAs), regulatory compliance documents, employee performance reviews, chatbot scripts and logs, call center analytics reports, customer relationship management (CRM) system data, customer onboarding documents, policy update communications, escalation procedures, customer loyalty program details, social media interaction records, marketing feedback documents, and/or emergency response protocols.

Use of the inter-institutional text analysis and comparison tool in customer service not only optimizes the management of customer interactions but also enhances the training, personalization, and effectiveness of customer service strategies. This leads to improved customer experiences, increased loyalty, and a stronger competitive edge in the market. By providing a reliable and efficient mechanism for document comparison and customer interaction analysis, the tool helps customer service organizations maintain well-organized, effective, and customer-focused operations.

### Content Moderation

The inter-institutional text analysis and comparison tool improves content moderation sector by providing tools for monitoring and analyzing online content. With capabilities to perform detailed similarity evaluations at various levels of text granularity, from entire articles to specific sections, the system helps in maintaining safe and respectful online environments.

The tool improves the precision of content moderation by automating the comparison of online content relative to community guidelines to identify and manage potentially harmful or plagiarized content. Capable of generating detailed similarity scores for individual sections, the tool ensures precise evaluations crucial for detecting inappropriate material and safeguarding online communities. This functionality allows content moderators and platform administrators to quickly identify content that is harmful, offensive, or in violation of copyright laws. This assists platforms in maintaining a safe online environment by ensuring that all posts, comments, and shared content comply with platform-specific rules and regulations, allowing for a proactive approach to content moderation.

Therefore, the system plays a role in helping online platforms comply with changing regulatory landscapes regarding online speech and content sharing. By maintaining up-to-date comparisons of content with legal requirements, platforms helps to avoid penalties and maintain good standing with regulatory bodies. The tool also aids businesses in protecting their brand integrity online by monitoring how their content is shared and discussed across social media and other platforms. This ensures that brand messaging is consistent and not associated with harmful or inappropriate content, safeguarding the company's public image and reputation.

Types of texts able to be analyzed by the tool with respect to government applications include, but are not limited to, user-generated content, moderation guidelines, complaint files, content review logs, automated filter logs, plagiarism reports, legal notices, content appeal records, hate speech analyses, misinformation flags, moderator training materials, community feedback summaries, policy update documents, regulatory compliance reports, safety protocol documents, cyberbullying records, intellectual property claims, analytics reports on content trends, platform terms of service, and/or emergency contact protocols.

The combination of the inter-institutional text analysis and comparison tool with content moderation not only optimizes the management of user-generated content but also enhances the safety, compliance, and integrity of online platforms. By providing a reliable and efficient mechanism for content moderation, the tool helps create a healthier digital environment, supporting the growth of positive online communities and interactions.

### Human Resources

The inter-institutional text analysis and comparison tool helps human resource departments by improving the recruitment process and supporting ongoing workforce development. With capabilities to perform detailed similarity evaluations at various levels of text granularity, from entire resumes to specific sections, the technology helps to align candidate qualifications with job requirements and thereby fosters a dynamic, skilled workforce.

The system enhances the recruitment process by accurately matching candidate resumes to job descriptions. Leveraging the capability to generate detailed similarity scores for individual sections of documents, this tool aligns candidate qualifications with job requirements, allowing for a highly targeted recruitment process. The tool serves assists in automating the matching process between qualifications listed on resumes and criteria specified in job descriptions, which assesses not just the overall compatibility of a candidate with the role but also delves into specific skills, experiences, and qualifications, increasing recruitment efficiency and reducing time-to-hire.

The present invention helps to streamline the initial screening process for human resources departments by automating the comparison of intricate details in resumes against job descriptions. This granular analysis aids recruiters in understanding the depth and relevance of each candidate's qualifications, enabling a more informed selection process.

It also supports ongoing workforce development by continuously comparing employee skills and experiences against evolving job descriptions and project requirements, identifying gaps in skills and areas for professional development, supporting HR strategies in training and development.

The system also helps in promoting diversity and inclusion within recruitment by providing an objective analysis based on the similarity scores of qualifications to job requirements to help remove unconscious biases from the recruitment process, ensuring a fair and equitable selection process.

Types of texts able to be analyzed by the tool with respect to government applications include, but are not limited to, resumes, job descriptions, employee performance reviews, training materials, recruitment advertisements, interview records, onboarding documents, compensation and benefits information, employee surveys, compliance documentation, workforce analytics reports, diversity and inclusion policies, labor agreements, exit interviews, promotion and succession planning documents, employee grievance files, workplace safety protocols, remote work policies, employee engagement programs, and/or HR policy manuals.

The use of the inter-institutional text analysis and comparison tool in human resources departments not only refines the recruitment process but also fosters a more dynamic, skilled, and diverse workforce. The tool aligns with modern HR needs, offering a sophisticated approach to managing human capital effectively and equitably.

### Translation Services

The inter-institutional text analysis and comparison tool improves translation services by providing precise tools for analyzing and comparing original texts with their translations. With capabilities to perform detailed similarity evaluations at various levels of text granularity, from entire documents to specific sections, the system ensures rigorous evaluations essential for maintaining the fidelity and cultural relevance of translated content.

The tool improves validation of translated documents by automating the comparison of original texts and their translations across different languages to ensure accuracy and cultural appropriateness. This functionality allows translators and language service providers to quickly identify discrepancies or errors in translation, ensuring that the translated content accurately reflects the original text's meaning and style.

It is also able to assist companies in ensuring that their marketing materials, legal documents, and product information are appropriately adapted for different cultural contexts while maintaining the original intent, style, and compliance with local regulations, which is especially important for multinational corporations operating in diverse markets. More particularly, the tool is able to help in managing multilingual content for organizations that operate websites or provide information in multiple languages. By analyzing and comparing content across different language versions, the tool helps ensure consistency and coherence across all translations.

The tool also aids educational institutions and academic publishers in ensuring that educational materials and scholarly articles are accurately translated. This supports the dissemination of knowledge and educational content globally, enabling access to information in native languages without losing the essence of the original work.

Types of texts able to be analyzed by the tool with respect to government applications include, but are not limited to, original texts, translated documents, localization guidelines, language style guides, translation memory files, glossaries, cultural adaptation records, client feedback, quality assurance ports, legal compliance documents, subtitling and dubbing scripts, marketing translation documents, technical manuals, website localization files, certification documents, interpretation logs, contractual agreements, copyright clearance documents, editorial comments, and/or project management files.

Integrating the system into the translation services not only optimizes the process of translating documents, but also enhances the quality and cultural appropriateness of translations. This leads to more effective communication and understanding across different languages and cultures, supporting global business operations, education, and research in an increasingly interconnected world.

### Publishing

The inter-institutional text analysis and comparison tool has application in the publishing industry by providing robust tools for manuscript plagiarism detection and similarity checks. With capabilities to perform detailed similarity evaluations at various levels of text granularity, from entire manuscripts to specific sections, this tool helps to maintain the originality and credibility of published content.

The present invention enhances the integrity of publications through advanced plagiarism detection and content originality analysis, and is capable of generating detailed similarity scores for individual sections. Specifically, the tool improves the manuscript review process by automating the comparison of submitted manuscripts against a vast database of published works and other submissions. This functionality allows editors and reviewers to quickly identify potential plagiarism or excessive similarity, ensuring that all published content is original. The tool also assists in the editorial decision-making process by providing editors with comprehensive reports on the originality of the content, allowing for a more informed review process and helps maintain the publication's reputation by preventing the dissemination of plagiarized content. On the other side, the tool supports authors and content creators in developing original content by highlighting sections of their manuscripts that are similar to existing works, allowing writers to revise and refine their work before submission, ensuring that their work meets originality standards and enhancing the overall quality of their contribution.

The system is also able to play a role in copyright compliance by enabling publishers to verify that all content respects intellectual property laws and credits appropriate sources. This is essential in academic and research publishing, where proper citation and acknowledgment of prior work are fundamental.

Types of texts able to be analyzed by the tool with respect to government applications include, but are not limited to, manuscripts, editorial reviews, copyright clearance documents, plagiarism reports, book proposals, publication contracts, print specifications, marketing plans, distribution agreements, royalty statements, reader reviews, book fair materials, sales data, book catalogs, author correspondence, peer review documents, proofs and galleys, digital publishing formats, subscription models, and/or legal disputes documents.

Integrating the inter-institutional text analysis and comparison tool into the publishing world not only optimizes the manuscript review and publication process but also enhances the integrity and credibility of published content. By providing a reliable platform for plagiarism detection and content originality analysis, the tool supports publishers in delivering high-quality, original content that respects intellectual property rights and contributes positively to the literary and academic communities.

### Library Sciences

The inter-institutional text analysis and comparison tool also has application in libraries by providing robust mechanisms for analyzing and comparing a wide array of library and archival documents. With capabilities to perform detailed similarity evaluations at various levels of text granularity, from entire documents to specific sections, the system allows for improved document cataloging, archival management, and accessibility.

The present invention enhances the efficiency and accuracy of cataloging and managing archival documents by automating the comparison of documents for ease of retrieval and historical preservation. Specifically, the tool is able to help in automating comparison of new acquisitions against existing collections, allowing librarians and archivists to quickly identify duplicates, related materials, or unique documents that need special attention or preservation methods.

The system assists institutions in comparing the condition and content of documents over time, helping monitor the degradation or changes in historical documents and implementing timely conservation efforts. The ability to precisely track changes or similarities in document conditions over time supports the long-term preservation of historical knowledge.

It is also able to be used in academic research by enabling scholars to efficiently locate and compare archival materials related to their study areas. By automating the discovery and comparison of relevant documents, the tool facilitates deeper research and scholarship, allowing researchers to uncover connections and insights that might otherwise remain hidden in expansive archival collections.

Finally, the tool helps libraries and archives in enhancing public access to collections by categorizing and linking documents in user-friendly ways based on content similarities and historical relevance. This not only improves the educational value of archival collections but also encourages public engagement with historical and cultural materials.

Types of texts able to be analyzed by the tool with respect to government applications include, but are not limited to, catalog records, archival documents, bibliographies, loan records, digital collections metadata, acquisition records, conservation reports, user research queries, interlibrary loan documents, library event records, reader advisory materials, library policies and procedures, accession lists, deaccession records, copyright clearance documents, patron registration files, education and training materials, library budget and funding documents, visitor logs and statistics, and/or surveys and feedback forms.

Integrating the inter-institutional text analysis and comparison tool into libraries not only optimizes the management of archival documents but also enhances the accessibility, preservation, and research value of library collections. By providing a reliable and efficient mechanism for document comparison and cataloging, the tool helps libraries and archives maintain well-organized, accessible, and preserved collections, supporting educational and cultural enrichment for communities.

### Environmental Studies

The inter-institutional text analysis and comparison tool has application in environmental studies providing robust mechanisms for analyzing and comparing a wide array of environmental documents. With capabilities to perform detailed similarity evaluations at various levels of text granularity, from entire documents to specific sections, the system allows for precise evaluations, important for enhancing regulatory compliance, environmental impact assessments, sustainability reporting, and environmental research.

The tool streamlines the analysis and comparison of environmental impact assessments, sustainability reports, and regulatory compliance documents, allowing for environmental management and policy-making. Regulatory compliance for documents is operable to be determined across different governments, including governments of different countries, as well as local governing bodies (ex: city, town, and state), state governments, and national governments.

The system improves the way environmental impact assessments are conducted by automating the comparison of environmental impact assessments (EIAs) with existing environmental standards and previously conducted studies, allowing environmental scientists and regulators to efficiently identify overlaps, discrepancies, and unique environmental impacts, and enhancing the effectiveness of environmental planning and protection measures.

The system assists corporations and organizations in comparing their sustainability initiatives with industry benchmarks and regulatory requirements, ensuring that reports accurately reflect the organization's environmental performance and adherence to sustainability goals, and helping maintain transparency with stakeholders and compliance with environmental regulations.

It also helps improve regulatory compliance by enabling government agencies and companies to compare their policies and operational procedures against environmental laws and standards. This ensures that operations are compliant with legal requirements, reducing the risk of non-compliance penalties and supporting environmental conservation efforts. The system therefore helps address the global challenge of environmental sustainability by enabling organizations to compare and validate compliance with environmental regulations across countries. This assists corporations, NGOs, and regulatory bodies in ensuring their operations meet international standards, promoting cohesive global efforts towards sustainability.

The system facilitates environmental research by allowing researchers to compare new findings with existing literature and studies, which is invaluable in identifying research gaps, corroborating findings, or noting significant deviations in data, and often leads to new insights and advancements in environmental science.

Types of texts able to be analyzed by the tool with respect to government applications include, but are not limited to, environmental impact assessments (EIAs), sustainability reports, regulatory compliance documents, research papers on environmental studies, environmental policy documents, climate change data, waste management plans, water quality reports, air quality reports, land use plans, energy consumption reports, biodiversity studies, corporate environmental audits, hazardous materials handling procedures, environmental licenses and permits, soil contamination studies, conservation plans, green building certifications, environmental litigation documents, and/or renewable energy project plans.

By integrating the inter-institutional text analysis and comparison tool into environmental studies, organizations and agencies are able to enhance the accuracy and efficiency of environmental assessments, compliance monitoring, and research. This tool not only supports more informed decision-making and policy development but also promotes a deeper understanding of environmental impacts, contributing to more effective conservation and sustainability efforts.

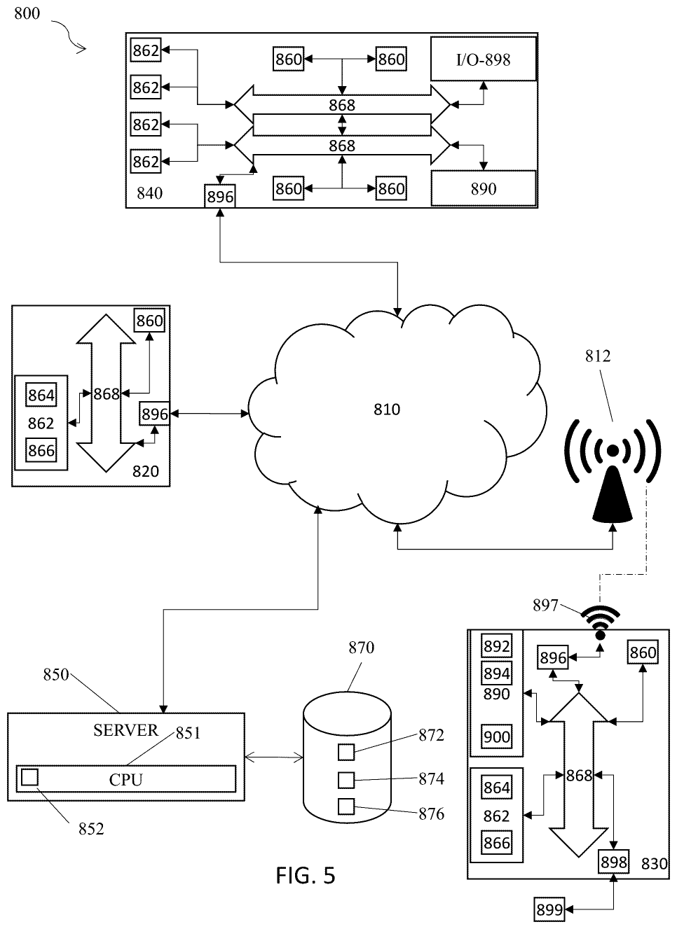

FIG. 5 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, gaming controllers, joy sticks, touch pads, signal generation devices (e.g., speakers), augmented reality/virtual reality (AR/VR) devices (e.g., AR/VR headsets), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 5, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 5, is operable to include other components that are not explicitly shown in FIG. 5, or is operable to utilize an architecture completely different than that shown in FIG. 5. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A system for evaluating and comparing credentials from separate institutions, comprising:
a server platform, wherein the server platform includes a processor and a memory;
a data collection module of the server platform configured to receive one or more text documents from a user device;
a machine learning module of the server platform configured to break up each of the one or more text documents into a plurality of sections based on structural and/or semantic qualities of the one or more text documents;
a natural language processing (NLP) module of the server platform configured to perform semantic analysis on the one or more text documents;
wherein the data collection module is configured to retrieve one or more additional text documents from one or more field knowledge databases;
wherein an assessment scale generator of the server platform generates similarity scores between the plurality of sections of the one or more text documents and a plurality of sections of the one or more additional text documents; and
wherein the one or more text documents include one or more academic transcripts.

2. The system of claim 1, wherein the assessment scale generator receives user-defined criteria defining one or more types of sections of the one or more text documents are high relevance, low relevance, or no relevance, and wherein the assessment scale generator generates the similarity scores in part based on the received user-defined criteria.

3. The system of claim 1, wherein the one or more text documents and the one or more additional text documents include one or more course descriptions and/or one or more syllabi for one or more academic courses.

4. The system of claim 1, wherein the machine learning module utilizes an unsupervised learning module in breaking up each of the one or more text documents into the plurality of sections.

5. The system of claim 1, wherein the data collection module includes at least one web crawler configured to automatically retrieve additional documentation from one or more online sources.

6. The system of claim 1, wherein the one or more text documents and the one or more additional text documents are not all the same language, and wherein the NLP module automatically translates at least one of the one or more text documents and/or the one or more additional text documents to ensure all text documents are in the same language.

7. The system of claim 1, wherein the similarity scores are percentage values.

8. The system of claim 1, wherein the assessment scale generator further generates a plurality of subscores analyzing similarity of one or more specific lines or one or more specific paragraphs of the one or more text documents relative to the one or more additional text documents.

9. A method for evaluating and comparing credentials from separate institutions, comprising:
providing a server platform including a processor and a memory;
a data collection module of the server platform receiving one or more text documents from a user device;
a machine learning module of the server platform breaking up each of the one or more text documents into a plurality of sections based on structural and/or semantic qualities of the one or more text documents;
a natural language processing (NLP) module of the server platform performing semantic analysis on the one or more text documents;
the data collection module retrieving one or more additional text documents from one or more field knowledge databases;
an assessment scale generator of the server platform generating similarity scores between the plurality of sections of the one or more text documents and a plurality of sections of the one or more additional text documents; and
wherein the one or more text documents include one or more academic transcripts.

10. The method of claim 9, further comprising the assessment scale generator receiving user-defined criteria defining one or more types of sections of the one or more text documents are high relevance, low relevance, or no relevance, and the assessment scale generator generating the similarity scores in part based on the received user-defined criteria.

11. The method of claim 9, wherein the one or more text documents and the one or more additional text documents include one or more course descriptions and/or one or more syllabi for one or more academic courses.

12. The method of claim 9, further comprising the machine learning module utilizing an unsupervised learning module in breaking up each of the one or more text documents into the plurality of sections.

13. The method of claim 9, wherein the data collection module includes at least one web crawler configured to automatically retrieve additional documentation from one or more online sources.

14. The method of claim 9, wherein the one or more text documents and the one or more additional text documents are not all the same language, and wherein the NLP module automatically translates at least one of the one or more text documents and/or the one or more additional text documents to ensure all text documents are in the same language.

15. The method of claim 9, wherein the similarity scores are percentage values.

16. The method of claim 9, further comprising the assessment scale generator generating a plurality of subscores analyzing similarity of one or more specific lines or one or more specific paragraphs of the one or more text documents relative to the one or more additional text documents.

17. A system for evaluating and comparing credentials from separate institutions, comprising:
a server platform, wherein the server platform includes a processor and a memory;
a data collection module of the server platform configured to receive one or more text documents from a user device;
a machine learning module of the server platform configured to break up each of the one or more text documents into a plurality of sections based on structural and/or semantic qualities of the one or more text documents;
a natural language processing (NLP) module of the server platform configured to perform semantic analysis on the one or more text documents;
wherein the data collection module is configured to retrieve one or more additional text documents from one or more field knowledge databases;
wherein an assessment scale generator of the server platform generates similarity scores between the plurality of sections of the one or more text documents and a plurality of sections of the one or more additional text documents; and
wherein the assessment scale generator receives user-defined criteria defining one or more types of sections of the one or more text documents are high relevance, low relevance, or no relevance, and wherein the assessment scale generator generates the similarity scores in part based on the received user-defined criteria.

18. The system of claim 17, wherein the data collection module includes at least one web crawler configured to automatically retrieve additional documentation from one or more online sources.

19. The system of claim 17, wherein the similarity scores are percentage values.

20. The system of claim 17, wherein the assessment scale generator further generates a plurality of subscores analyzing similarity of one or more specific lines or one or more specific paragraphs of the one or more text documents relative to the one or more additional text documents.
